(19) United States
(12) Patent Application Publication
(10) Pub. No.: US 2025/0290394 A1
(43) Pub. Date: Sep. 18, 2025

(54) SYSTEM AND METHOD FOR GEOLOGICAL MODEL UPSCALING

(71) Applicant: SAUDI ARABIAN OIL COMPANY, Dhahran (SA)

(72) Inventor: Hussain ALFAYEZ, Dhahran (SA)

(73) Assignee: SAUDI ARABIAN OIL COMPANY, Dhahran (SA)

(21) Appl. No.: 18/605,555

(22) Filed: Mar. 14, 2024

(51) Int. Cl. E21B 43/16; G06T 17/05

(52) U.S. Cl. CPC E21B 43/16; G06T 17/05; E21B 2200/20; E21B 2200/22

(57) ABSTRACT

Systems and methods are disclosed relating to geological model upscaling. Training data representative of previously captured, generated, and/or recorded detailed geological data for one or more subsurfaces of a planet can be received. A diffusion model can be trained based on the training data to optimize parameters of the diffusion model. Detailed geological data for a respective subsurface of the planet can be received, and the detailed geological data can be upscaled using the trained diffusion model. Upscaled geological data can be generated based on the upscaling. In some examples, an upscaled geological model representative of the respective subsurface can be generated based on the upscaled geological data. The upscaled geological model can be simulated to model a behavior of the respective subsurface.

### FIELD OF THE DISCLOSURE

This disclosure relates to geological modeling, and more particularly, to upscaling a geological model.

### BACKGROUND OF THE DISCLOSURE

A geological model can be used to provide a detailed representation of subsurface geological structures and properties. These models can be used to understand a distribution of hydrocarbons (e.g., oil, gas, etc.) in a planet's (e.g., Earth's) subsurface, for exploration, drilling, and/or production activities. A subsurface is a region beneath a surface of a planet, which can extend from a ground and/or seafloor downward to a depth within the planet. A subsurface can encompass one or more layers and/or materials that lie beneath a surface, including rocks, sediments, fluids, and/or geological structures.

### SUMMARY OF THE DISCLOSURE

Various details of the present disclosure are hereinafter summarized to provide a basic understanding. This summary is not an extensive overview of the disclosure and is neither intended to identify certain elements of the disclosure nor to delineate the scope thereof. Rather, the primary purpose of this summary is to present some concepts of the disclosure in a simplified form prior to the more detailed description that is presented hereinafter.

According to an embodiment, a method can include receiving training data representative of previously captured, generated, and/or recorded detailed geological data for one or more subsurfaces of a planet, training the diffusion model based on the training data to optimize parameters of the diffusion model, receiving detailed geological data for a respective subsurface of the planet, upscaling the detailed geological data using the trained diffusion model, and generating upscaled geological data based on the upscaling.

According to another embodiment, a system can include one or more computing platforms configured to: train a diffusion model according to a feature preservation constraint, process detailed geological data using the trained diffusion model to provide upscaled geological data, generating an upscaled geological model based on the upscaled geological data, simulating the upscaled geological model to simulate a subsurface of a planet, outputting simulation data based on the simulation of the upscaled geological data, and providing the simulation data to an output device.

In yet another embodiment, a system can include one or more non-transitory computer-readable media that can include data and machine readable instructions that can be executable by a processor. The machine readable instructions can include a diffusion model programmed to: upscale detailed geological data for a respective subsurface of a planet and generate upscaled geological data based on the upscaling. The machine readable instructions can further include a diffusion training algorithm programmed to train the diffusion model based on training data to optimize parameters of the diffusion model. The training data can be representative of previously captured, generated, and/or recorded detailed geological data for one or more subsurfaces of the planet.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is an example of a block diagram of a system with a geological upscaler for upscaling detailed geological data to provide upscaled geological data.

FIG. 2 is an example of a method of upscaling fine-scale geological data to coarse scale geological data.

FIG. 3 is an example of a method of a diffusion process.

FIG. 4 is an example of a method for upscaling detailed geological data.

FIG. 5 is an example of a method for simulating a subsurface of a planet.

FIG. 6 is an example of a graph providing a simplified visualization of a feature preservation constraint.

FIG. 7 is an example of a computing environment that can be used to perform one or more methods according to an aspect of the present disclosure.

FIG. 8 is an example of a cloud computing environment that can be used to perform one or more methods according to an aspect of the present disclosure.

FIG. 9 is a block diagram of a system implementing a geological upscaler according to an aspect of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Examples are disclosed herein relating to upscaling geological models. Geological models are used to represent a subsurface of a planet, for example, Earth, or another plant, such as Mars. A reservoir is a component of a subsurface geological structure of the planet and is a particular formation that has an ability to store and/or transmit fluids, such as hydrocarbons (e.g., oil and gas), or water. A geological model of a reservoir can be referred to as a reservoir model or reservoir geological model. The reservoir model can characterize a subsurface reservoir where hydrocarbons can be trapped. Such models can be used by reservoir engineers and geoscientists to optimize oil and gas recovery. Example other types of geological models can include, but not limited to, structural models, stratigraphic models, petrophysical models, seismic models, fluid flow models, and/or other types of models. The term “geological model” as used herein can include any type of model that can represent a subsurface of a planet. Geological models can be used to represent different aspects of the subsurface of the planet.

A geological model can be created using high-resolution data, which can be obtained from geological surveys, well logs, seismic studies, and/or other data sources. Such models can be referred to as fine-scale geological models as these models provide a detailed representation of geological features of an area of the subsurface (or subsurface area). A fine-scale geological model can capture small-scale variations in properties, for example, rock type, porosity, permeability, and fluid saturation, as an example. The fine-scale geological model can include intricate details of geological formations, such as thin beds, small-scale faults, and subtle variations in rock properties, in some instances. Thus, a fine-scale geological model can provide a highly detailed view of the subsurface, in some instances, at a scale of individual rock layers or even smaller features.

Because geological models are highly detailed, simulation of such models can be difficult or challenging. For example, simulating fluid flow and/or other processes at such fine scales is computationally intensive and often impractical. To reduce a complexity of such models, a technique known as or referred to as “upscaling” can be used. Upscaling reduces the complexity of the fine-scale geological model to a more efficient or manageable level, allowing simulations to be run within a reasonable time (or period) and computational resource limits. Upscaling can be used to provide a coarse representation of the fine-scale geological model, which can be referred to as a coarse geological model, or upscaled geological model. Upscaling is used in a field of geoscience, particularly in applications such as reservoir simulation and seismic inversion. Upscaled geological models provide an in-depth representation of the subsurface and can capture a spatial distribution of geological characteristics. Spatial distribution in geology can involve a mapping of different geological attributes across a region. These characteristics can include, but not limited to, rock types, faults, folds, porosity, permeability, mineral content, fossil content, and other geological properties.

In some instances, upscaling is used to drive decision making processes (e.g., to provide a more generalized view of a reservoir, which can be useful for strategic decision making an understanding an overall behavior of the reservoir), resolve data limitation problems (e.g., downhole and seismic data can provide detailed information about certain aspects of a reservoir, however, there are limitations in data resolution and coverage and upscaling can help in making the best use of available data by integrating it into a larger-scale model that can be more representative of the entire reservoir), representing a large area (e.g., geological models often need to represent large areas or volumes and upscaling allows for the inclusion of all relevant geological features and variations over these large areas in a more generalized but still accurate way), resource allocation and planning (e.g., upscaling helps in optimizing resource allocation by providing a macro view of the reservoir, and thus aid in planning more efficient extraction strategies, placement of wells, and/or designing recovery processes), enable effective simulation, interpretation, decision-making processes in resource extraction and/or geoscientific studies. Accordingly, in simplistic terms, the upscaled geological model is a simplified version of the fine-scale geological model.

To generate the upscaled geological model, detailed geological data (that is used for generating the fine-scale geological model) is transformed into a form that can be used for geological modeling, while retaining essential attributes and characteristics of original data (the detailed geological data data). An upscaling process begins with high-resolution, detailed geological data. This data can include, for example, porosity, permeability, rock types, fluid saturation levels, and can be obtained from well logs, core samples, seismic surveys, and/or other geological studies. This fine-scale data can then be transformed into a coarser scale to provide upscaled data. For example, this can involve averaging, homogenizing, and/or otherwise summarizing the detailed data into larger blocks or cells. The purpose of the transformation is to capture essential characteristics of the data over a larger volume or area while reducing an overall complexity of the data, and consequently a model generated on the data. The upscaled data can then be used to provide the upscaled geological model.

A common technique for transforming the detailed geological data is by using a deterministic algorithm. The deterministic algorithm can transform the detailed geological data into the upscaled data through a series of systematic steps, without involving randomness or probabilistic elements. This transformation process typically involves aggregating or averaging the detailed geological data to represent same properties at a larger scale. The algorithm identifies key parameters that need to be translated from a fine-scale to a coarse-scale. These parameters are essential for a type of geological model being created, such as a reservoir simulation model. The algorithm then aggregates the detailed geological data over larger volumes or areas. This could involve averaging values of a property (e.g., like porosity) over a larger block of the subsurface. The aggregation method is chosen based on how best to represent the geological characteristics at a coarser scale. In some cases, the algorithm can homogenize the detailed geological data, which can involve creating a uniform representation of the data over larger areas. Despite the generalization, deterministic algorithms often include steps to ensure that critical geological features (like major faults or high-permeability channels) are preserved in the upscaled model. These features can significantly influence the behavior of a geological system and must be accurately represented. After the initial upscaling, the resulting data (the upscaled data) is often validated and calibrated against real-world observations and measurements to ensure that the coarse-scale model remains realistic and reliable. Finally, the transformed data is used to provide an upscaled geological model. This model can then be used for simulations and analyses.

Existing techniques, including the deterministic algorithm, used for upscaling fail to capture one or more complex spatial relationships between different geological features, which results in a loss of detail and accuracy in the final model (the upscaled geological data). Geological features (or structures) can refer to one or more physical components of the subsurface of a planet. By way of example, geological structures can include formations like faults, folds, and layers, while geological features encompass attributes like porosity and lithology. For example, existing techniques fail to capture complex spatial relationships in geological features due to a rigid structure (e.g., systematic and predetermined approach) of these algorithms. For example, in a geological setting with interbedded sandstone and shale layers, the existing technique can oversimplify the interface between these layers which leads to inaccuracies in modeling. This simplification results in a loss of critical details such as an extent of sand bodies or shale barriers, which can be needed for accurate fluid flow modeling in reservoir simulations. Furthermore, existing approaches do not account for inherent uncertainty and variability in geological structures. This can result in upscaled models that are not representative of an underlying geology, having significant implications for applications such as reservoir simulation.

Examples are disclosed herein for upscaling geological models that capture the one or more complex spatial relationships between the different geological features that existing approaches are unable to capture. According to one or more examples herein, a generative model is employed. A generative model is a type of machine learning model that is trained to generate new data samples that are similar to a given dataset. The generative model can be trained to learn an underlying distribution of data and use this knowledge to produce new samples. Example generative models can include, but not limited to, generative adversarial networks (GANs), variational autoencoders (VAEs), and diffusion models. A diffusion model is a type of generative model that functions (programmed to) to gradually transform a random distribution of data (e.g., usually starting with noise) into a structure pattern or data distribution that resembles training data). According to one or more examples herein, a diffusion model can be used in a process for geological upscaling. In some examples a diffusion process can be implemented by or using the diffusion model, which can be referred to in some instances as a “diffusion PriorScale” and thus the diffusion model can be referred to as “a diffusion PriorScale model.” The one or more examples herein, can use one or more probabilistic diffusion models that have been tailored and optimized for geological upscaling.

In one or more examples herein a geological upscaler is employed. The geological upscaler can utilize a diffusion model for implementing upscaling and offer technical improvements and advantages over existing approaches upscaling processes (or methods). Because the geological upscaler uses a probabilistic model, the geological upscaler provides a statistical framework for representing uncertainty and variability in geological structures. This allows for generation of multiple plausible upscaled models that can capture a range of possible geological scenarios. Furthermore, the geological upscaler uses the diffusion model to reverse a diffusion process from observed data to noise (e.g., Gaussian noise), which enables the diffusion model to learn a data distribution (e.g., of the detailed geological data) in a non-parametric way. The diffusion model and thus the geological upscaler can resultantly capture the complex spatial relationships between different geological features, leading to more accurate and detailed upscaled models, which existing approaches suffer from.

In one or more examples herein, a feature preservation constraint can be used by the geological upscaler. The constraint can be used so that an upscaled geological data accurately captures inherent geological features and a heterogeneity of the detailed geological data, which can be referred to as a fine-scale geological data. Consequently, upscaled models generated by the geological upscaler according to one or more examples herein are more geologically realistic in contrast to upscaled models generated according to existing techniques. The geological upscaler uses a probabilistic generative model with the feature preservation constraint in some instances to enable the geological upscaler to generate a range of plausible upscaled models (the upscaled geological data) that accurately capture the complexity and heterogeneity of the fine-scale geological data.

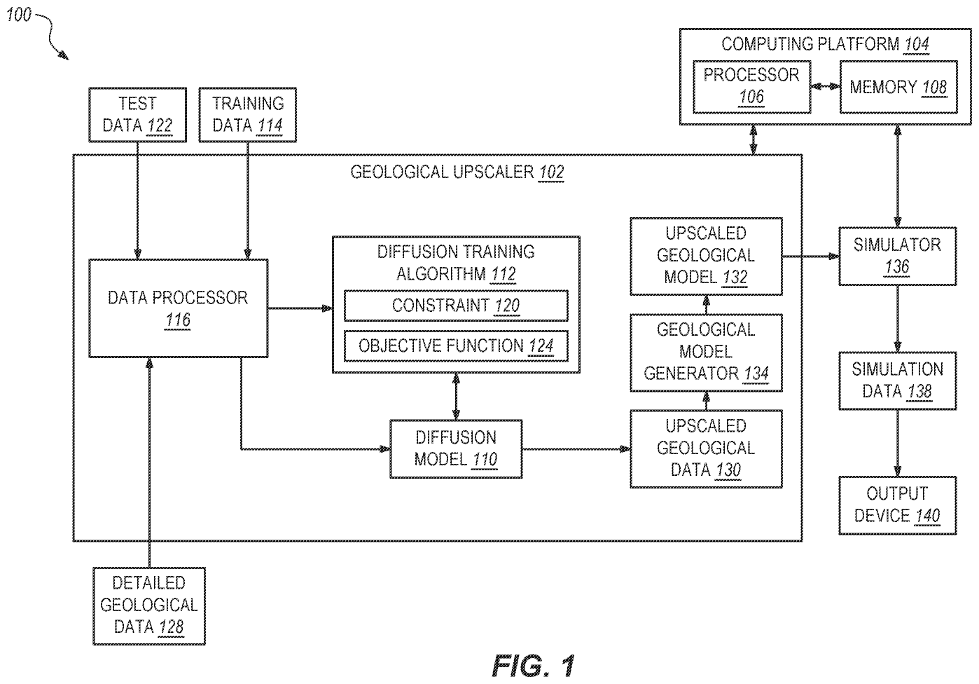

FIG. 1 is an example of a block diagram of a system 100 with a geological upscaler 102 that can be used for upscaling the detailed geological data 128 to provide upscaled geological data 130. In some examples, the geological upscaler 102 (or the system 100) can be used to provide an upscaled geological model 132. The geological upscaler 102 can be implemented using one or more modules, shown in block form in the drawings. The one or more modules can be in software or hardware form, or a combination thereof. In some examples, the geological upscaler 102 can be implemented as machine readable instructions for execution on one or more computing platforms 104 (referred to as a computing platform herein), as shown in FIG. 1. The computing platform 104 can include one or more computing devices selected from, for example, a desktop computer, a server, a controller, a blade, a mobile phone, a tablet, a laptop, a personal digital assistant (PDA), and the like.

The computing platform 104 can include a processor 106 and a memory 108. By way of example, the memory 108 can be implemented, for example, as a non-transitory computer storage medium, such as volatile memory (e.g., random access memory), non-volatile memory (e.g., a hard disk drive, a solid-state drive, a flash memory, or the like), or a combination thereof. The processor 106 can be implemented, for example, as one or more processor cores. The memory 108 can store machine-readable instructions that can be retrieved and executed by the processor 106 to implement the geological upscaler 102. Each of the processor 106 and the memory 108 can be implemented on a similar or a different computing platform. The computing platform 104 can be implemented in a cloud computing environment (for example, as disclosed herein) and thus on a cloud infrastructure. In such a situation, features of the computing platform 104 can be representative of a single instance of hardware or multiple instances of hardware executing across the multiple of instances (e.g., distributed) of hardware (e.g., computers, routers, memory, processors, or a combination thereof). Alternatively, the computing platform 104 can be implemented on a single dedicated server or workstation.

The geological upscaler 102 can include a diffusion model 110. The diffusion model 110 can be trained, for example, during a training phase, for upscaling (or upscale processing) of the detailed geological data 128. The training phase can include a model training step and a model validation step. In some examples, the geological upscaler 102 includes a diffusion training algorithm 112. In other examples, the diffusion training algorithm is implemented separately from the geological upscaler 102. The diffusion training algorithm 112 can be used to train the diffusion model 110 based on training data 114. The training data 114, for example, can include one or more seismic data (e.g., seismic images), well log data (e.g., resistivity, porosity, density, sonic velocities, etc.), porosity data (e.g., porosity images) and/or permeability data (e.g., permeability maps), geological data (e.g., geological maps), geochemical data (e.g., information about a chemical composition of rocks and fluids in the subsurface), geophysical data (e.g., gravity and magnetic survey data), production data (e.g., in context of reservoir studies), and/or other subsurface geological features. The training data 114 can correspond to or be representative of previously captured, generated, and/or recorded detailed geological data. The training data 114 can represent a variety and complexity of geological features and properties that are relevant to a particular application (e.g., by way of example, fluid flow simulation). Thus, the training data 114 can provide a comprehensive view of subsurface geology. Thus, the training data 114 can include spatial relationships. Seismic data can capture spatial relationships between different data points. The training data 114 can be obtained from various sources such as seismic surveys, well logs, and/or geological maps, for example. In some examples, the training data 114 is provided to a data processor 116 to prepare the training data 114 for use by the diffusion training algorithm 112 to train the diffusion model 110. For example, the data processor 116 can apply one or more data processing techniques to the training data 114. The one or more data processing techniques can include, but not limited to, noise reduction, normalization, and formatting the training data 114 into a suitable form for input to the diffusion model 110.

In some examples, the training of the diffusion model 110 can involve a forward and a reverse phase. The diffusion model 110 can perform a diffusion process, which includes a forward diffusion process, which can be implemented during the forward phase, and reverse denoising process, which can be implemented during the reverse phase. The diffusion training algorithm 112 can train the diffusion model 110 and thus can orchestrate the forward and reverse phases during the training phase. During the forward phase, the diffusion training algorithm 112 can add noise (e.g., gradually over a number of iterations or steps and thus incrementally) to the training data 114 in a controlled manner to cause the diffusion model 110 to transform the training data 114 into a random noise state. The diffusion training algorithm 112 can follow a predefined schedule or pattern for adding the noise. The diffusion training algorithm 112 can manage how the noise is added during the forward phase. The diffusion training algorithm 112 can determine an amount and type of noise to add at each step and thus cause the diffusion process to degrade the data into a noise-dominant state. The diffusion model 110 can add the noise from the diffusion training algorithm 112 to the training data 114. The nature of this noise can be Gaussian, meaning that at each step, the training data 114 can be altered by adding a small amount of random variation that follows a Gaussian distribution. Other noise distributions are contemplated within the scope of this disclosure. The diffusion model 110 can incorporate noise into the training data 114 (at each step) and learns from this process. The diffusion model 110 can learn a pattern (noise pattern) how data changes as noise is added and thus learn a noise pattern. This learning can be used by the diffusion model 110 to reverse this process in the reverse phase. By the end of the forward diffusion process, the training data 114 has been transformed to a state where its structure is predominantly determined by a Gaussian noise and can be referred to as noisy data. In other words, the training data 114 is obscured by noise to a point that it can resemble a random sample from a Gaussian distribution.

In some examples, during the forward diffusion process, the diffusion model 110 can use expression (1), where the training data 114 can be gradually transformed by the added noise into a distribution (e.g., a Gaussian distribution):

$$\frac{dx}{dt} = β ( x ) - 0.5 {σ}^{2} + σ dB ( t ) , \qquad ( 1 )$$

wherein x the training data 114, t is the time, β(x) is a drift term, o is a diffusion term, and β(t) is a Brownian motion.

Accordingly, during the forward phase, as noise is incrementally added, the diffusion model 110 observes how detailed features and structures of the training data 114 gradually disappear into randomness. By learning these progressive changes, the diffusion model 110 can learn about underlying patterns and structures within the training data 114. The diffusion model 110 can learn how the training data 114 transitions from a structured state to a random noise state. In a reverse phase, the diffusion model 110 can use what it has learned to generate or reconstruct data by reversing the noise pattern it learned during the forward phase. For example, starting from the noisy data, the diffusion model 110 (e.g., under control or in response to the diffusion training algorithm 112) can progressively remove the noise, reconstructing the data back to its original form, the training data 114.

For example, during the reverse denoising process, the diffusion model 110 can use expression (2) (an iterative expression) to reverse a noise addition process and thus learn to recover the training data 114 from the noise (e.g., Gaussian noise):

$${x}_{t - 1} = {x}_{t} + \sqrt{Δ t} ξ - Δ t ∇ log p ( {x}_{t} ) , \qquad ( 2 )$$

wherein xₜ is the training data 114 at time t, ∇t is the time step, ξ is a Gaussian noise, and ∇ log p(xₜ) is the gradient of the log probability of the data at time t.

For example, the diffusion model 110 can be parameterized by a set of parameters, denoted as theta (θ), which can be learned during the training phase. The parameters, denoted as theta (θ), can include: learning rate parameters: dictating the speed at which the model learns during training, noise levels parameters: defining the amount and type of noise added during the forward diffusion phase, iteration parameters: determining the number of iterations or steps in the diffusion process, and weight parameters: influencing how different features or aspects of the data are prioritized during the learning process. These parameters are related to the expressions (1) and (2) and can influence how the diffusion model 110 performs the diffusion and denoising processes. For example, the noise level parameters can influence (impact) the forward diffusion process of expression (1), while the learning rate and weight parameters can influence the reverse denoising process of expression (2). The precise manner in which these parameters interact with these expressions can depend on the specific implementation of the diffusion model 110.

For example, during training, the diffusion model 110 can learn a prior distribution over a dataset (the training data 114). The diffusion model 110, during its training phase, analyzes the fine-scale geological data (the training data) and learns the statistical characteristics of this data. This learning involves understanding the distributions, patterns, and regularities within the data. The learned prior distribution is a Bayesian concept. The learned prior distribution presents a model's initial understanding or hypothesis about the geological structures before it processes new or unseen data. When new data is input into the model, Bayesian inference is used to update this prior knowledge with new information, leading to a posterior distribution. This process allows the model to refine its predictions and outputs based on both its initial training (the prior) and new data it encounters. The diffusion model 110 is trained to map a noisy model to respective noise-free counterparts, effectively learning a data distribution in a non-parametric way. The set of parameters can govern a behavior of the diffusion model 110 in the denoising and/or upscaling processes. For example, the behavior of the diffusion model 110 can be governed by its parameters which influence how it processes data. For instance, a parameter determining noise level in the data can affect the model's ability to recognize and retain important geological features. High noise levels make the model learn more robust features, while lower levels might focus on preserving fine details. The set of parameters can be used for interpreting noise levels and structuring in the reverse denoising process. The parameters can influence how the diffusion model 110 analyzes geological details and scales such details up, and thus can impact both a fidelity and an accuracy of the upscaled geological model 132.

The set of parameters of the diffusion model 110, represented by the theta (θ), can be optimized during the training phase, and can be referred to as optimized parameters. Once the set parameters have been optimized, denoted as θ\hat{ }, theta hat, and thus determined, the optimized parameters can be used in the reverse denoising process and upscaling processes, as disclosed herein. For example, once the diffusion model 110 is trained (e.g., during a testing or validation phase, or also known as an inference phase of the testing phase), the diffusion model 110 based on the optimized parameters processes the detailed geological data 128. This can involve gradually increasing noise levels and allowing the diffusion model 110 to map noisy images back to an original, noise-free state. This iterative process continues until an output image aligns with the learned prior distribution. As disclosed herein, the diffusion model 110 is trained using an iterative process where noise is gradually introduced into geological data. This process teaches the diffusion model 110 how to identify and restore the original, noise-free state of the data. Over successive iterations, the diffusion model 110 learns to denoise the data more effectively, moving closer to what it learned during training (the learned prior distribution). The iterative process of adding and removing noise is guided by the model's parameters, which can be optimized during training. These parameters dictate how much noise is added, how the model interprets this noise, and how it reconstructs the original data from the noisy version. The optimization ensures that the model's denoising and upscaling behaviors are finely tuned for the best possible performance on geological data.

In some instances, during the training, a feature preservation constraint 120 is used to ensure that a generative process (e.g., the reverse denoising process) of the diffusion model 110 adheres to specific geological conditions and requirements. For example, the geological conditions can include maintaining structural integrity of geological formations, such as a continuity and alignment of sediment layers, fault lines, and fractures. In some examples, the geological conditions can include preservation of porosity and permeability characteristics of rock layers. The requirements for a generative process can include requiring that the upscaled model accurately represent the original fine-scale geological data, minimizing the loss of critical details, being robust sufficiently to handle a wide range of geological scenarios and variations, ensuring consistent performance across different types of geological formations, and/or the upscaled model preserving statistical properties of the original data, such as histograms of rock properties or spatial autocorrelation characteristics. The feature preservation constraint can be used during a model's training phase. The diffusion model 110, having been trained with this constraint, inherently remembers and applies the principles of feature preservation when processing new data. The feature preservation constraint 120 can be used to minimize a disparity between input data (detailed geological data), and output data (upscaled geological data). The feature preservation constraint 120 can be used to ensure that geological features, for example, stratification, porosity gradients, and lithological variations can be accurately maintained in the upscaled geological data. The feature preservation constraint 120 can be used to quantitatively measure a difference between input data provided to the diffusion model 110 and output data generated by the diffusion model 110. This measurement can be used in guiding an upscaling process by providing feedback to the system, enabling it to adjust and improve the upscaling results, for example, during a testing phase. In some examples, during the training phase, (e.g., validation step), the diffusion model 110 can apply what it has learned during training to new, unseen data, which can be test data 122. The test data 122 can include similar or substantially similar data points as the training data 114 used for training the diffusion model 110. In some examples, the training data 114 can be split into two datasets, a first dataset for training the diffusion model 110 and a second dataset for testing the diffusion model 110, which can correspond to the test data 122.

In some examples, the feature preservation constraint 120 can be represented according to expression (3):

$$c ( x , y ) = {‖ f ( x ) - y ‖}^{2} \qquad ( 3 )$$

wherein f(x) is the upscaled geological data, y is detailed geological data (e.g., the training data 114), and ∥ ∥² is the squared Euclidean norm.

For example, the expression (3) can represent the feature preservation constraint 120 that can guide the upscaling process to adhere to specific conditions or requirements. This constraint can serve as a tool to measure the difference between input data to the diffusion model 110 and output data provided by the diffusion model 110 to guide the diffusion model 110 towards better upscaling results. The term “ideal upscaling” as used herein can refer to a theoretical benchmark, representing a best possible upscaled version (of the input to the diffusion model 110) and that retains all essential geological details from the input (the training data 114). Example essential geological details can refer to particular characteristics of the subsurface (or reservoir) that impact fluid flow and performance. This can include properties such as porosity, permeability, and geological heterogeneities. Ensuring these details are retained the upscaling process can be calibrated during training to maintain accuracy in representing these critical features.

Thus, the feature preservation constraint 120, denoted as c(x, y) in expression (3), can be defined on fine-scale data given some additional information “y”. The feature preservation constraint 120 can be used to integrate the learned diffusion prior to influence the upscaling process. In the context of the feature preservation constraint denoted as c(x,y) in the model, the “y” can represent additional, relevant information about the geological data that assists in the upscaling process. This can include specific geological attributes like rock density, mineral content, and/or other contextual data that helps the diffusion model 110 in accurately reconstructing and upscaling the fine-scale data (represented by “x”). The integration of the feature preservation constraint 120 into the diffusion model 110 can be implemented by embedding it into the model's learning process, specifically in how the diffusion model 110 approaches an upscaling task. During training, the diffusion model 110 can learn to not only upscale the fine-scale data “x” but also to do so while considering and preserving the information represented by “y”. This can be implemented by modifying a model's loss function (the function that measures a model's performance) to include terms that represent the constraint. Thus, the diffusion model 110 can be trained to minimize this loss, which now includes not only upscaling accurately but also preserving the features and attributes denoted by “y”. This way, a learned diffusion prior, which is a model's initial understanding of a data distribution, can be influenced by both the fine-scale data and the additional information “y”, which results in a more accurate and realistic upscaling process. The feature preservation constraint 120 can be used to ensure that the upscaled geological model 132 accurately captures inherent geological features and heterogeneity of the detailed geological data 128. The feature preservation constraint 120 can be used in combination with the iterative denoising process to upscale the training data 114 to a coarser resolution, which can include applying the diffusion model 110 to the training data 114 according to the feature preservation constraint 120, to generate upscaled data.

In some examples, during the training, the diffusion training algorithm 112 can use an objective function 124 to quantify how far off a prediction (e.g., actual upscaled data) of the diffusion model 110 is from a desired outcome (e.g., target or desired upscaled data). The objective function 124 can be used to control a training of the diffusion model 110. For example, during the training phase, the diffusion model 110 can adjust its parameters (or the diffusion training algorithm 112 adjusts its parameters) to minimize a value of the objective function 124 which can indicate how close the prediction is to the desired outcome. The parameters adjusted in the diffusion model 110 can include noise levels, learning rate, and/or other aspects like neural network weights and model architecture. During the training phase, an optimization process (e.g., which can be implemented by an optimizer of the diffusion training algorithm) can be used to optimize an accuracy of the diffusion model 110. In some examples, the objective function 124 includes the feature preservation constraint 120.

In some examples, the objective function 124 can be represented according to the following and can be used as part of the optimization process:

$${Min}_{x} E [ c ( x , y ) ] + λ KL ( p ( x ) \vert \vert q ( x ) ) , \qquad ( 4 )$$

wherein E is an expectation, KL is a Kullback-Leibler divergence, p(x) is a prior distribution, q(x) is a posterior distribution, and λ is a trade-off parameter.

In some examples, the diffusion model 110 can be used to compute the prior distribution p(x) and the posterior distribution q(x). The prior distribution p(x) can correspond to the learned prior distribution (e.g., from training). The diffusion model 110 can be implemented to use Bayesian inference. In Bayesian inference, the process can begin with a prior belief or knowledge about an unknown parameter, represented as a probability distribution called the “prior”. The posterior distribution of a parameter θ given observed data D can be formulated as follows:

$$P ( θ \vert D ) ∝ P ( D \vert θ ) \times P ( θ ) . \qquad ( 4 )$$

In expression (4), P(θ) is a prior and can represent an initial knowledge or assumption (information) about a subsurface, which can be derived from historical data, expert judgment, and/or other sources. For example, the information can include, but not limited to, rock properties, fluid distributions, geological formations, and/or any other relevant subsurface feature.

In expression (4), P (D|θ) s a likelihood and given a set of parameters θ, it can represent a probability of observing the fine-scale geological data (the detailed geological data 128) D. In the context of upscaling, this can be thought of as how likely the observed fine-scale data is under a particular upscaled model.

In expression (4), (θ|D) is a posterior and represents a belief about the subsurface after considering the fine-scale geological data. The posterior can combine the initial knowledge (prior) with the new data (likelihood) to give a more comprehensive understanding of the subsurface.

For example, upscaling geological data using Bayesian inference in the diffusion model 110 can be implemented as follows. The geological upscaler 102 can establish a prior distribution. The diffusion model 110 can define an initial belief distribution (prior) based on historical data or expert knowledge. The diffusion model 110 can observe data and calculate a likelihood. For example, when the diffusion model 110 encounters (receives) new geological data the diffusion model 110 can use the data to calculate the likelihood, evaluating how well this new data (new geological data) aligns with the current model parameters (e.g., settings and/or value within the diffusion model 110). The diffusion model 110 can update to a posterior distribution. For example, the diffusion model 110 can update beliefs using a Bayesian formula (e.g., expression (4)), and thus reflect changes based on the observed data. The diffusion model 110 can repeat the observing of the data, calculating the likelihood, and updating the iterative learning with each new set of data, and thus refine a model's understanding over time. The diffusion model 110 can be utilized after the above iterative learning process. For example, the diffusion model 110 can be used for accurate geological upscaling.

The diffusion model 110 can be used to implement Bayesian upscaling to determine the upscaled model (or set of parameters θ) that maximizes the posterior distribution. This can be achieved using various optimization techniques, such as Markov Chain Monte Carlo (MCMC) or Variational Inference, or other types of optimization techniques. The Bayesian approach is a robust method that considers uncertainty from our prior knowledge and current observations. Continuously integrating new data into the diffusion model 110 can enhance ensures that the upscaled geological model 132 aligns with both existing and recent information.

Accordingly, the diffusion model 110 can be implemented according to a Bayesian framework that uses a learned prior distribution as a prior to produce the upscaled geological data 130. The diffusion model 110, trained on detailed geological data, can represent an initial understanding of the subsurface. As new fine-scale geological data is fed into the system 100, the diffusion model 110 can update this prior to produce or provide the upscaled geological data 130. Implementing the diffusion model 110 based on a Bayesian framework can ensure that the upscaled geological data 130 is geologically realistic, which can provide a robust method for integrating uncertainty from both prior knowledge and observed fine-scale data.

As such, the denoising diffusion generative model serves as a prior by defining a probability distribution over geological model space. The term “geological model space” refers to a range of possible geological scenarios and structures that the diffusion model 110 can predict or simulate based on its training. This distribution, utilized as a constraint during fine-scale model upscaling, guarantees that upscaled models are plausible and align with the fine-scale models. The combination of synthetic data, upscaling error, and the mathematical constraint provides a framework to guide the diffusion model 110 toward producing upscaled geological models that are as close as possible to a conceptual ideal. Thus, while perfect upscaling (ideal upscaling) may be unattainable, the use of synthetic data, upscaling error analysis, and mathematical constraints in the diffusion model 110 provides a method to come as close as possible to this ideal (in some instances meeting ideal upscaling). The invention's value lies in this iterative, guided approach to upscaling, which aims to improve upon traditional deterministic methods. During upscaling, the learned prior distribution acts as a constraint, ensuring that the upscaled models are plausible and align with fine-scale models.

In some examples, such as during application, the diffusion model 110 can upscale the detailed geological data 128 to provide the upscaled geological data 130. For example, the inference engine 126 can use Bayesian inference, wherein the diffusion model 110 is the prior distribution and the detailed geological data 128 is the posterior distribution, to provide the upscaled geological data 130. In some examples, the geological upscaler 102 can include a geological model generator 134 that can be configured to provide the upscaled geological model 132 based on the upscaled geological data 130. The geological upscaler 102 can provide the upscaled geological model 132 with a greater amount of upscaled information in comparison to upscaled geological models generated using existing systems (or techniques). In some examples, a simulator 136 can be used to simulate the upscaled geological model 132. The simulator 136 can be implemented as machine readable instructions that can be executed on a computing platform, for example, the computing platform 104, as shown in the example of FIG. 1. In some examples, the simulator 136 can be configured to model a behavior of fluids (e.g., water, oil and/or gas) within geological formations). Thus, in some examples, the simulator 136 is a geological or reservoir simulator and the upscaled geological model 132 is a reservoir flow simulation model. For example, the simulator 136 can simulate fluid flow using the upscaled geological model 132 to provide simulation data 138. For example, the simulation data 138 can include information related to a flow and behavior of the fluids within the geological formations.

The simulation data 138 can include, but not limited to, in some instances, pressure and temperature data (e.g., at various points within the geological formation), fluid flow rates and directions data (e.g., data on how fluids (like oil, gas, water) are moving through the geological formation, including flow rates and the direction of flow), saturation level data (e.g., Data on the saturation levels of different fluids (e.g., oil saturation, water saturation) within the reservoir), and/or porosity and permeability distribution data (e.g., data on the porosity (the void spaces in the rock) and permeability (the ability of the rock to transmit fluids) throughout the upscaled geological model 132). In some examples, the simulation data 138 can include data estimating a size and productive capacity of the reservoir, which are vital for resource management and economic planning, data projecting future production rates based on current and planned extraction activities, recovery efficiency data indicating how much of the resource (like oil or gas) can be effectively extracted from the reservoir with current technology and methods, data indicating uncertainties and risks associated with various aspects of reservoir behavior and resource extraction and/or data characterizing effects of different extraction methods, like water flooding or hydraulic fracturing, on the reservoir.

In some examples, the simulation data 138 can be provided to an output device 140, such as disclosed herein. For example, the simulation data 138 can be rendered on a display, or a device for a user. The simulation data 138 can be used to influence field operations. For instance, the simulation data 138 can be used to guide decisions on where to drill, a selection of drilling instruments, or even broader strategies like field development planning and reservoir management. The simulation data 138 provides a more accurate representation of the subsurface, leading to more efficient and effective resource extraction and management. In some examples, the geological upscaler 102 can issue a command based on the simulation data 138 and/or the upscaled geological model 132. The command can be provided to another device or system to cause an action.

In some examples, the upscaled geological model 132 generated based on the upscaled geological data 130 can undergo a verification process to verify an accuracy of the upscaled geological model 132. For example, this can be achieved by conducting a comparative analysis between results (e.g., the simulation data 138) obtained from the upscaled geological model 132 and data collected from field observations or by comparing the results with the results of a high-resolution simulation (e.g., from a simulation of detailed geological model). Based on this verification, the diffusion model 110 can be adjusted iteratively, allowing for repeated iterations of the process until satisfactory outcomes are achieved.

The geological upscaler 102 can address several technical challenges in the realm of geological modeling and seismic inversion. The geological upscaler 102 uses Bayesian upscaling and a diffusion model to address several technical problems in an integration gap between seismic data and reservoir flow simulation models. The term “integration gap” refers to a disparity between low-resolution seismic data and high-resolution flow simulation models. The geological upscaler 102 bridges this gap by using the diffusion model 110 to upscale flow simulation models while preserving one or more select (or desired) features. This unification provides a more coherent and comprehensive view of the subsurface. The geological upscaler 102 can bridge the gap ensuring a unified understanding of carbon dioxide (CO₂) behavior as it preserves geological details during upscaling, enhancing the accuracy of predictions. Also, its iterative refinement process assists in reconciling any inconsistencies between the two data sources, providing more aligned and reliable predictions for CO₂ sequestration. Seismic data has a low resolution and flow simulation models have a high resolution. The geological upscaler 102 can be used as a unified model to capture all the essential features that can be required. The geological upscaler 102 iterative refinement process addresses discrepancies between seismic data (low-resolution) and high-resolution flow simulation models. Seismic data provides a broad but low-resolution view, while flow simulation models offer detailed, high-resolution information but the certainty is very low away from wells locations. By integrating both data sources, the geological upscaler 102 creates a unified model that can capture essential features. This results in a coarse grid model that can retain the fine and important details from the high-resolution model.

Accordingly, the geological upscaler 102 can be used for upscaling fine-scale geological data to coarser scales using diffusion priors as a constraint. In some examples, the diffusion training algorithm 112 can be used to train the diffusion model 110 on the fine-scale geological data (the training data 114) and then using this model as a prior for upscaling. By incorporating the diffusion prior as a constraint, the upscaled geological model 132 can capture the underlying geological features and heterogeneity of the reservoir at a greater accuracy in contrast to existing upscaling approaches. The upscaling of the geological upscaler 102 has several advantages over traditional upscaling approaches or methods. The geological upscaler 102 can be computationally efficient, allowing for faster simulations at coarser scales. The geological upscaler 102 can also preserve essential features of the detailed geological data 128, leading to more accurate predictions of reservoir behavior. The geological upscaler 102 can also be used in combination with other techniques such as history matching and data assimilation to improve accuracy further and reduce uncertainty. Thus, in the oil and gas industry, the geological upscaler 102 can be used to improve reservoir simulation (e.g., its accuracy), which can lead to improved decision-making and maximizing production.

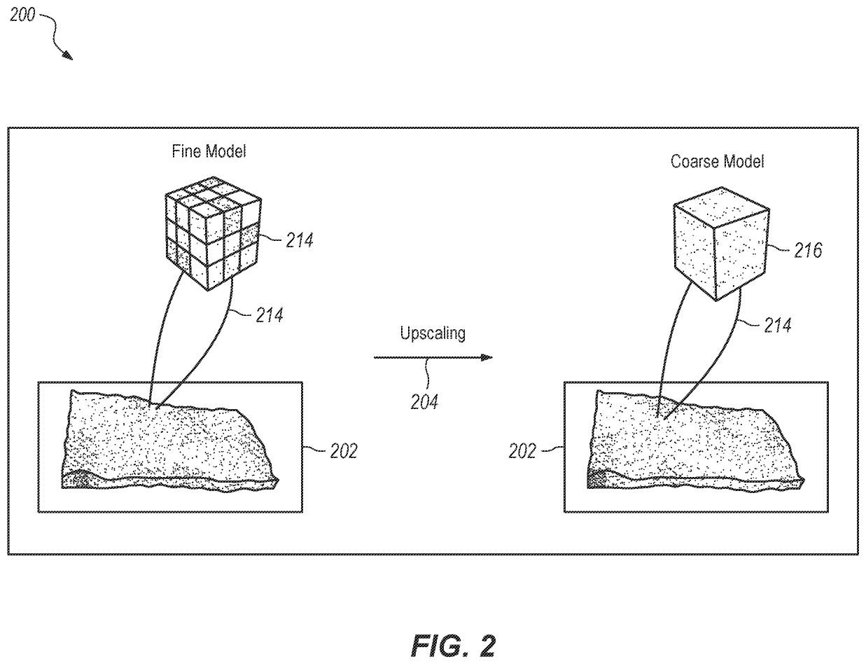

In view of the foregoing structural and functional features described above, example methods will be better appreciated with reference to FIGS. 2-5. While, for purposes of simplicity of explanation, the example methods of FIGS. 2-5 are shown and described as executing serially, it is to be understood and appreciated that the present example is not limited by the illustrated order, as some actions could in other examples occur in different orders, multiple times and/or concurrently from that shown and disclosed herein. Moreover, it is not necessary that all described actions be performed to implement the method.

FIG. 2 is an example of a method 200 of upscaling fine-scale geological data to coarse scale geological data. In some examples, the method 200 can be implemented by the geological upscaler 102, as shown in FIG. 1. Thus, reference can be made to one or more examples of FIG. 1 in the example of FIG. 2. The method 200 can begin at 202 by receiving or retrieving detailed geological data for a subsurface, such as the detailed geological data 128. At 204, the detailed geological data can be processed using a diffusion model (e.g., the diffusion model 110, as shown in FIG. 1) to upscale the detailed geological data 128 to provide upscaled geological data, such as the upscaled geological data 130, as shown in FIG. 1. In some instances, in the example of FIG. 2, at 208 a coarse-scale model 210 can be generated based on the upscaled geological data. The coarse-scale model 210 can correspond to the upscaled geological model 132, as shown in FIG. 1. In some instances, a fine-scale (or detailed) model 212 can be generated at 214 based on the detailed geological data. In other examples, the step at 214 is omitted.

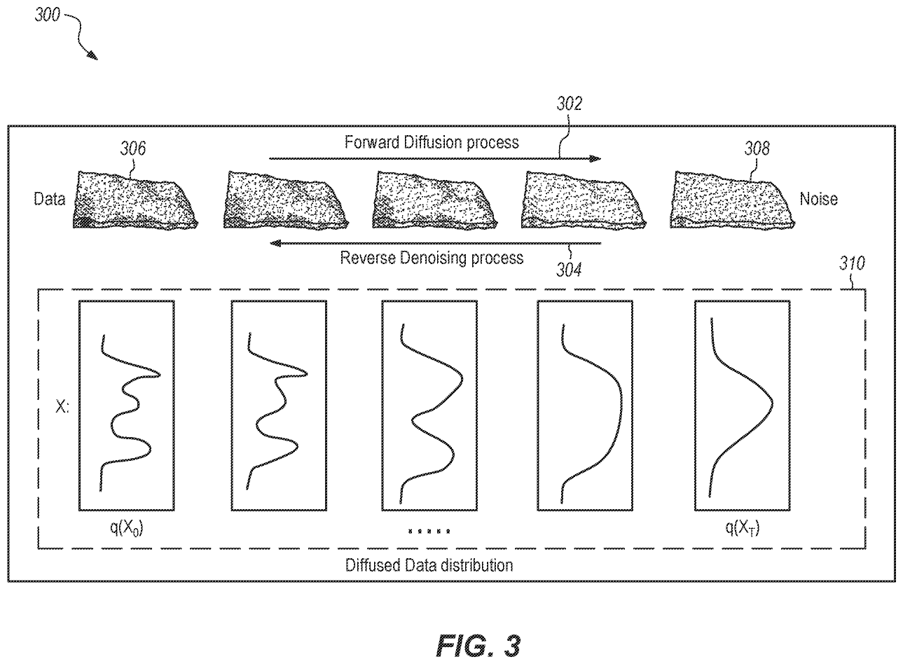

FIG. 3 is an example of a method 300 of a diffusion process. In some examples, the method 300 can be implemented by the geological upscaler 102, as shown in FIG. 1. Thus, reference can be made to one or more examples of FIGS. 1-2 in the example of FIG. 3. For example, the method 300 can be implemented by the diffusion model 110. The diffusion process can include a forward diffusion process 302 and a reverse denoising process 304. During the forward diffusion process 302, noise is added to the detailed geological data 128. In this phase, the diffusion model 110 can gradually add noise to the detailed geological data 128. This process is done step-by-step over several iterations, moving from clear detailed geological data 306 (e.g., a clear image) to noisy detailed geological data 310 (e.g., noisy image), as shown in FIG. 3. In each step, the data becomes noisier (or corrupted). During the reverse denoising process 304 noise is removed from the noisy detailed geological data 310 to recover the clear detailed geological data 306. Starting from random noise, the diffusion model 110 gradually constructs the detailed geological data (e.g., an image) by removing the noise in a step-wise fashion. At each step, the diffusion model 110 can predict a less-noisy version of the current image, progressively denoising it. At each step, a diffused data distribution is computed at 310 by the diffusion model 110. During a training phase, the diffused data distributions can be referred to or define the prior distribution. By contrast, during an application phase (e.g., after training), the diffusion model 110 can provide the diffused data distribution at 310, which can be the posterior distribution.

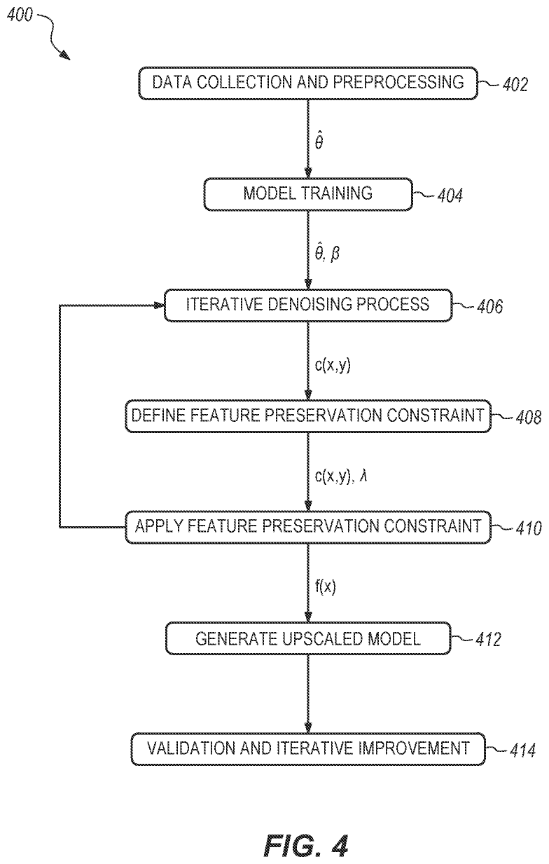

FIG. 4 is an example of a method 400 of a method for upscaling detailed geological data 128, as shown in FIG. 1. The method 400 can be implemented by the geological upscaler 102, as shown in FIG. 1. Thus, reference can be made to one or more examples of FIGS. 1-3 in the example of FIG. 4. The method 402 can begin by receiving fine-scale geological data (e.g., the training and/or the test data 114 and 122). This data can be obtained from various sources such as seismic surveys, well logs, or geological maps. The data can be preprocessed (e.g., by the data processor 116, as shown in FIG. 1) to prepare it for a generative model (e.g., the diffusion model 110, as shown in FIG. 1). This preprocessing could involve tasks such as noise reduction, normalization, and formatting the data into a suitable form for input into the model.

At 404, the denoising diffusion generative model can be trained. For example, step 404 in some instances can include feeding the preprocessed data into the model and allowing it to learn a prior distribution over the dataset. The model can be trained to map noisy models to noise-free counterparts, effectively learning the data distribution in a non-parametric way. The parameters of the model, represented by theta (θ), can be optimized during this training process. Once the model is trained, the optimized parameters, denoted as θ\hat{ }, can be used in the denoising and upscaling processes.

At 406, a denoising process can be applied using the trained model to input data iteratively. For example, this can include gradually increasing noise levels and allowing the model to map the noisy images back to original, noise-free state. This iterative process can continue until the output image aligns with the learned prior distribution. At 408, the feature preservation constraint, denoted as c(x, y), can be defined on the fine-scale model given some additional information “y”. This constraint can integrate the learned diffusion prior and guide the upscaling process. It can ensure that the upscaled model accurately captures the inherent geological features and heterogeneity of the fine-scale model. At 410, the constraint can be used in combination with an iterative denoising process to upscale the fine-scale geological model to a coarser resolution. This can involve applying the denoising diffusion generative model to the fine-scale data, guided by the feature preservation constraint, to generate the upscaled model (e.g., the upscaled geological model 132, as shown in FIG. 1) at 412, as shown in FIG. 4. At 414, in some examples, the method 400 can include a verification process for the upscaled model where the upscaled model is compared to existing findings or field data to verify a model accuracy. This can be achieved by conducting a comparative analysis between the results obtained from the scaled-up model and data collected from field observations or by comparing them with the outcomes of a high-resolution simulation. Based on this verification, the upscaled model can be adjusted iteratively, allowing for repeated iterations of the process until satisfactory outcomes are achieved.

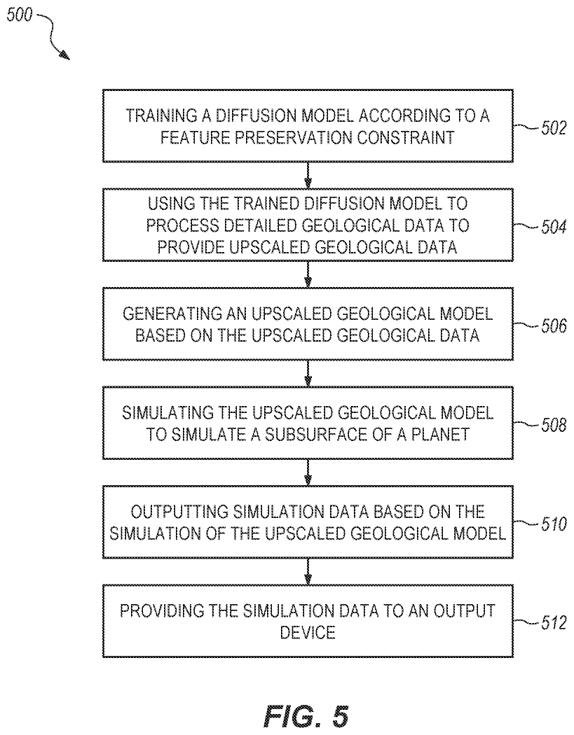

FIG. 5 is an example of a method 500 for simulating a subsurface of a planet, such as the upscaled geological model 132, as shown in FIG. 1. At least one or more steps of the method 500 can be implemented by the geological upscaler 102, as shown in FIG. 1. Thus, reference can be made to one or more examples of FIGS. 1-4 in the example of FIG. 5. The method 500 can begin at 502 with training (e.g., using the diffusion training algorithm 112) a diffusion model (e.g., the diffusion model 110, as shown in FIG. 1) according to a feature preservation constraint (e.g., the feature preservation constraint 120, as shown in FIG. 1). At 504, the trained diffusion model can be used to process detailed geological data (e.g., the detailed geological data 128, as shown in FIG. 1) to provide upscaled geological data (e.g., the upscaled geological data 130, as shown in FIG. 1). At 506, the upscaled geological model (e.g., the upscaled geological model 132, as shown in FIG. 1) can be generated based on the upscaled geological data. At 508, the upscaled geological model can be simulated (e.g., using the simulator 136, as shown in FIG. 1) to simulate the subsurface of the planet. At 510, simulation data (e.g., the simulation data 138, as shown in FIG. 1) can be outputted based on the simulation. In some instances, at 512, the simulation data can be provided on an output device (e.g., the output device 140, as shown in FIG. 1).

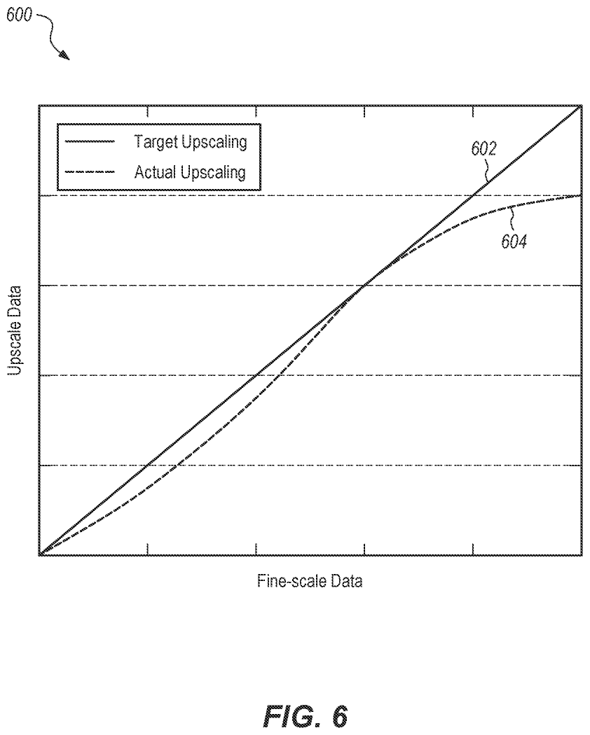

FIG. 6 is an example of a graph 600 providing a simplified visualization of a feature preservation constraint, such as the feature preservation constraint 120, as shown in FIG. 1, in an upscaling process. Thus, reference can be made to one or more examples of FIGS. 1-5 in the example of FIG. 6. An x-axis of the graph 600 represents fine-scale data, and a y-axis of the graph 600 represents the upscaled data. A line 602 of the graph 600 is a “Target Upscaling” and can represent an ideal relationship between input and output data of the diffusion model, such as the diffusion model 110, as shown in FIG. 1. The line 602 can pass through an origin and increases linearly, indicating that as the input data becomes more detailed, the output data also becomes more detailed. The feature preservation constraint aims to minimize this disparity, guiding the upscaling process to produce an output (shown as line 604 in the example of FIG. 6) that more closely follows the line 602. This ensures that upscaled geological data (e.g., the upscaled geological data 130, as shown in FIG. 1) accurately captures the inherent geological features and heterogeneity of detailed geological data (e.g., the detailed geological data 128, as shown in FIG. 1). This constraint integrates the learned diffusion prior and guides the upscaling process.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention is not limited to the embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

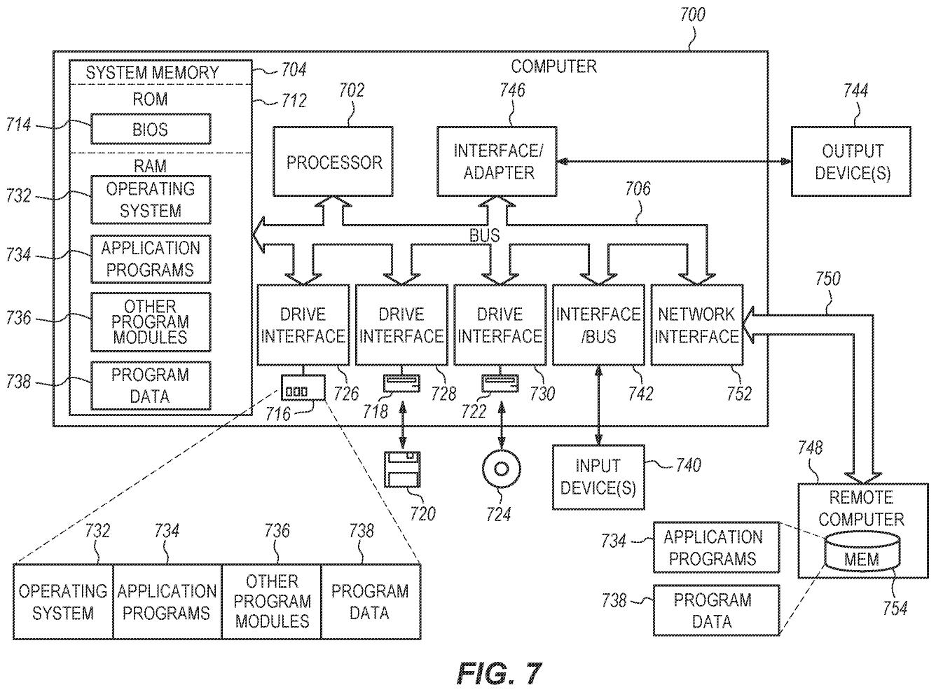

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 7. Thus, reference can be made to one or more examples of FIGS. 1-6 in the example of FIG. 7.

In this regard, FIG. 7 illustrates one example of a computer system 700 that can be employed to execute one or more embodiments of the present disclosure. Computer system 700 can be implemented on one or more general purpose networked computer systems, embedded computer systems, routers, switches, server devices, client devices, various intermediate devices/nodes or standalone computer systems. Additionally, computer system 700 can be implemented on various mobile clients such as, for example, a personal digital assistant (PDA), laptop computer, pager, and the like, provided it includes sufficient processing capabilities.

Computer system 700 includes processing unit 702, system memory 704, and system bus 706 that couples various system components, including the system memory 704, to processing unit 702. Dual microprocessors and other multi-processor architectures also can be used as processing unit 702. System bus 706 may be any of several types of bus structure including a memory bus or memory controller, a peripheral bus, and a local bus using any of a variety of bus architectures. System memory 704 includes read only memory (ROM) 710 and random access memory (RAM) 712. A basic input/output system (BIOS) 714 can reside in ROM 712 containing the basic routines that help to transfer information among elements within computer system 700.

Computer system 700 can include a hard disk drive 716, magnetic disk drive 718, e.g., to read from or write to removable disk 720, and an optical disk drive 722, e.g., for reading CD-ROM disk 724 or to read from or write to other optical media. Hard disk drive 716, magnetic disk drive 718, and optical disk drive 722 are connected to system bus 706 by a hard disk drive interface 726, a magnetic disk drive interface 728, and an optical drive interface 730, respectively. The drives and associated computer-readable media provide nonvolatile storage of data, data structures, and computer-executable instructions for computer system 700. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and disclosed herein. A number of program modules may be stored in drives and RAM 710, including operating system 732, one or more application programs 734, other program modules 736, and program data 738. In some examples, the application programs 734 can include one or more modules (or block diagrams), or systems, as shown and disclosed herein. Thus, in some examples, the application programs 734 can include the geological upscaler 102, as shown in FIG. 1.

A user may enter commands and information into computer system 700 through one or more input devices 740, such as a pointing device (e.g., a mouse, touch screen), keyboard, microphone, joystick, game pad, scanner, and the like. These and other input devices are often connected to processing unit 702 through a corresponding port interface 742 that is coupled to the system bus, but may be connected by other interfaces, such as a parallel port, serial port, or universal serial bus (USB). One or more output devices 744 (e.g., display, a monitor, printer, projector, or other type of displaying device) is also connected to system bus 706 via interface 746, such as a video adapter.

Computer system 700 may operate in a networked environment using logical connections to one or more remote computers, such as remote computer 748. Remote computer 748 may be a workstation, computer system, router, peer device, or other common network node, and typically includes many or all the elements described relative to computer system 700. The logical connections, schematically indicated at 750, can include a local area network (LAN) and a wide area network (WAN). When used in a LAN networking environment, computer system 700 can be connected to the local network through a network interface or adapter 752. When used in a WAN networking environment, computer system 700 can include a modem, or can be connected to a communications server on the LAN. The modem, which may be internal or external, can be connected to system bus 706 via an appropriate port interface. In a networked environment, application programs 734 or program data 738 depicted relative to computer system 700, or portions thereof, may be stored in a remote memory storage device 754.

Although this disclosure includes a detailed description on a computing platform and/or computer, implementation of the teachings recited herein are not limited to only such computing platforms. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models (e.g., software as a service (Saas, platform as a service (PaaS), and/or infrastructure as a service (IaaS)) and at least four deployment models (e.g., private cloud, community cloud, public cloud, and/or hybrid cloud). A cloud computing environment can be service oriented with a focus on statelessness, low coupling, modularity, and semantic interoperability.

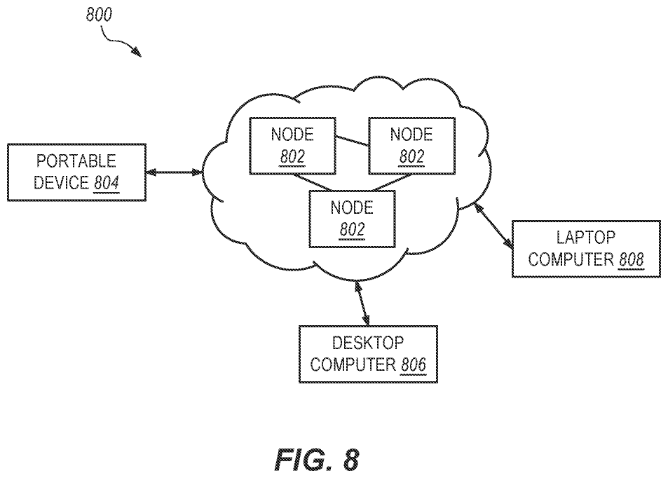

FIG. 8 is an example of a cloud computing environment 800 that can be used for implementing one or more modules and/or systems in accordance with one or more examples, as disclosed herein. Thus, reference can be made to one or more examples of FIGS. 1-7 in the example of FIG. 8. As shown, cloud computing environment 800 can include one or more cloud computing nodes 802 with which local computing devices used by cloud consumers (or users), such as, for example, personal digital assistant (PDA), cellular, or portable device 804, a desktop computer 806, and/or a laptop computer 808, may communicate. The computing nodes 802 can communicate with one another. In some examples, the computing nodes 802 can be grouped (not shown) physically or virtually, in one or more networks, such as Private, Community, Public, or Hybrid clouds, or a combination thereof. This allows the cloud computing environment 800 to offer infrastructure, platforms and/or software as services for which a cloud consumer does not need to maintain resources on a local computing device. The devices 804-808, as shown in FIG. 8, are intended to be illustrative and that computing nodes 802 and cloud computing environment 800 can communicate with any type of computerized device over any type of network and/or network addressable connection (e.g., using a web browser). In some examples, the one or more computing nodes 802 are used for implementing one or more examples disclosed herein relating to root-source identification. Thus, in some examples, the one or more computing nodes can be used to implement modules, platforms, and/or systems, as disclosed herein.

In some examples, the cloud computing environment 800 can provide one or more functional abstraction layers. It is to be understood that the cloud computing environment 800 need not provide all of the one or more functional abstraction layers (and corresponding functions and/or components), as disclosed herein. For example, the cloud computing environment 800 can provide a hardware and software layer that can include hardware and software components. Examples of hardware components include: mainframes; RISC (Reduced Instruction Set Computer) architecture based servers; servers; blade servers; storage devices; and networks and networking components. In some embodiments, software components include network application server software and database software.

In some examples, the cloud computing environment 800 can provide a virtualization layer that provides an abstraction layer from which the following examples of virtual entities may be provided: virtual servers; virtual storage; virtual networks, including virtual private networks; virtual applications and operating systems; and virtual clients. In some examples, the cloud computing environment 800 can provide a management layer that can provide the functions described below. For example, the management layer can provide resource provisioning that can provide dynamic procurement of computing resources and other resources that are utilized to perform tasks within the cloud computing environment. The management layer can also provide metering and pricing to provide cost tracking as resources are utilized within the cloud computing environment 800, and billing or invoicing for consumption of these resources. In one example, these resources may include application software licenses. Security provides identity verification for cloud consumers and tasks, as well as protection for data and other resources. The management layer can also provide a user portal that provides access to the cloud computing environment 800 for consumers and system administrators. The management layer can also provide service level management, which can provide cloud computing resource allocation and management such that required service levels are met. Service Level Agreement (SLA) planning and fulfillment can also be provided to provide pre-arrangement for, and procurement of, cloud computing resources for which a future requirement is anticipated in accordance with an SLA.

In some examples, the cloud computing environment 800 can provide a workloads layer that provides examples of functionality for which the cloud computing environment 800 may be utilized. Examples of workloads and functions which may be provided from this layer include: mapping and navigation; software development and lifecycle management; virtual classroom education delivery; data analytics processing; and transaction processing. Various embodiments of the present disclosure can utilize the cloud computing environment 800.

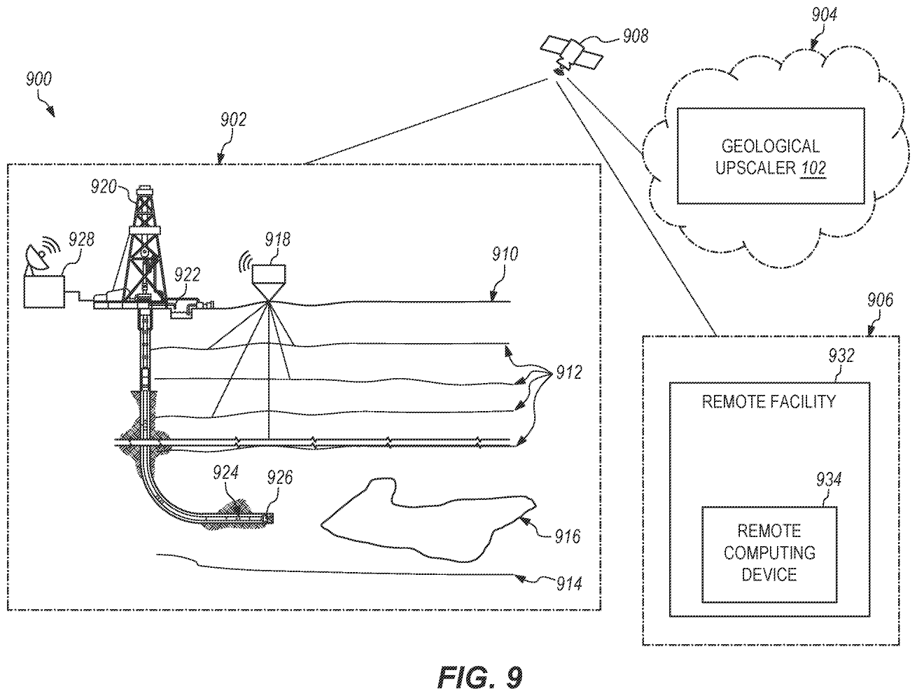

FIG. 9 is a block diagram of a system 900 implementing a geological upscaler according to an aspect of the present disclosure. FIG. 9 is a block diagram of a system 900 that can be employed to implement a system including the geological upscaler 102, as shown in FIG. 1, in accordance with certain embodiments. Thus, reference can be made to one or more examples of FIGS. 1-8 in the example of FIG. 9. In one or more examples, one or more of the elements shown in FIG. 9 may be omitted, repeated, replaced with similar elements, and or substituted. Accordingly, embodiments should not be considered limited to the specified arrangement of elements shown in FIG. 9.

System 900 includes a field 902, a cloud system 904, a remote system 906, and a communication relay 908. The communication relay 908 may include one or more components that enable remote communications. The components may include satellites, antennas, routers, repeaters, modems, fiber optic cabling, coaxial cabling, or other like electronic, wireless, or optical networking technologies that enable communications over distances.

While the field 902 is an onshore field, or a field having resources within a subterranean land formation, in other examples, the field 902 is an offshore field, or a field having resources within a subsea or underwater formation. In other examples, the system 900 includes one or more onshore fields, one or more offshore fields, and/or a combination thereof. For example, the remote project 932 of the remote system 906 may be a second onshore field. The field 902 is communicatively coupled to the cloud system 904 and/or the remote system 906 via the communication relay 908, for example. The cloud system 904 provides resources over the internet. The cloud system 904 may be a cloud-provider system as shown in FIG. 9, for example. In a non-limiting example, the remote system 906 may be a system for controlling one or more operations of the field 902. The remote system 906 may include a computing device 934 for controlling the one or more operations of the field 902, for example. The computing device 934 may be a computer system or computer platform, as disclosed herein.

The field 902 includes a subterranean formation 910 having multiple sedimentary layers 912, one or more fault lines 914, and one or more resources 916. The multiple sedimentary layers, one or more fault lines 914, and one or more resources 916 can be detected using a seismic source, such as source 918, a well logging tool, such as well logging tool 924 having a drill bit 926, or a combination thereof. The field 902 also includes a well 920 using a water resource 922 and having a control system 928.

In certain embodiments, the control system 928 may be communicatively coupled to geological upscaler 102 via the communication relay 908. The geological upscaler 120 can influence field operations by providing detailed and accurate subsurface models. This information can guide decisions like well placement, drilling strategies, or reservoir management techniques. By offering a more accurate representation of the subsurface, the geological upscaler 102 can assist in optimizing resource extraction, reducing operational risks, and enhancing overall efficiency. The geological upscaler 102 can provide one or more signals to the control system 928.

For example, the geological upscaler 102 can output or generate a model of a reservoir (e.g., the upscaled geological model 132). The model can reveal one or more characteristics: variations in porosity and permeability across the reservoir, presence of a high-permeability channel within the reservoir that was not previously identified, and/or predicted pressure differentials that could impact fluid flow. Based on this model and in some instances subsequent simulations predicting fluid flow and reservoir pressure changes over time (e.g., the simulation data 138, as shown in FIG. 1), the geological upscaler 102 can send a command to the control system 928. The control system 928 can adjust a drilling plan for an upcoming well based on the command. For example, the command could be a drilling adjustment command. The command could indicate to adjust a planned trajectory of Well X to target a high-permeability channel identified in Sector Y. The command could indicate that the drilling angle should be adjusted to 35 degrees at a depth of 2,500 meters to maximize exposure to the channel. In some examples, the command could indicate setting drilling fluid pressure to a specific value that mitigates the risk of fracturing the reservoir rock. The command could be formulated by the geological upscaler 102 based on the upscaled geological model's insights. Thus, the geological upscaler 102 can be used to optimize oil and gas recovery by directing drilling efforts towards the most productive areas of the reservoir while minimizing operational risks such as drilling-induced fractures.

Embodiments disclosed herein include:
A. A computer-implemented method comprising: receiving training data representative of previously captured, generated, and/or recorded detailed geological data for one or more subsurfaces of a planet; training the diffusion model based on the training data to optimize parameters of the diffusion model; receiving detailed geological data for a respective subsurface of the planet; upscaling the detailed geological data using the trained diffusion model; and generating upscaled geological data based on the upscaling.
B. A system comprising: one or more computing platforms configured to: train a diffusion model according to a feature preservation constraint; process detailed geological data using the trained diffusion model to provide upscaled geological data; generating an upscaled geological model based on the upscaled geological data; simulating the upscaled geological model to simulate a subsurface of a planet; outputting simulation data based on the simulation of the upscaled geological data; and providing the simulation data to an output device.
C. One or more non-transitory computer-readable media comprising data and machine readable instructions executable by a processor, the machine readable instructions comprising: a diffusion model programmed to: upscale detailed geological data for a respective subsurface of a planet; generate upscaled geological data based on the upscaling; and a diffusion training algorithm programmed to train the diffusion model based on training data to optimize parameters of the diffusion model, the training data representative of previously captured, generated, and/or recorded detailed geological data for one or more subsurfaces of the planet.

Each of embodiments A through C may have one or more of the following additional elements in any combination: Element 1: generating an upscaled geological model representative of the respective subsurface based on the upscaled geological data; Element 2: simulating the upscaled geological model to model a behavior of the respective subsurface; Element 3: generating simulation data based on the simulation, the simulation data characterizing a hydrocarbon in the respective subsurface, the simulation data being used for planning and/or extraction of the hydrocarbon; Element 4: generating simulation data based on the simulation, the simulation data being provided to an output device; Element 5: wherein the training comprises providing the training data the diffusion model to learn a prior distribution over the preprocessed data; Element 6: wherein the diffusion model is trained according to a feature preservation constraint, the feature preservation constraint using the learned prior distribution to influence an upscaling implemented by the diffusion model of the detailed geological data; Element 7: wherein the training comprises applying an optimization process to the diffusion model using an objective function to optimize an accuracy of the diffusion model, the objective function being based on the feature preservation constraint; Element 8: wherein the simulation data characterizing a hydrocarbon in the respective subsurface, the simulation data being used for planning and/or extraction of the hydrocarbon; Element 9: wherein the feature preservation constraint using a learned prior distribution during a training to influence an upscaling implemented by the diffusion model of the detailed geological data; Element 10: wherein the one or more computing platforms are further configured to apply an optimization process to the diffusion model using an objective function to optimize an accuracy of the diffusion model during the training, the objective function being based on the feature preservation constraint; Element 11: wherein the one or more computing platforms are further configured to use training data to train the diffusion model to learn the prior distribution over the training data; Element 12: wherein the one or more computing platforms are further configured to preprocess the training data to provide pre-processed data, the pre-processed data being in a suitable form for ingestion by the diffusion model, the diffusion model being trained based on the pre-processed data; Element 13: wherein the diffusion training algorithm is further programmed to train the diffusion model according to a feature preservation constraint, the feature preservation constraint using the learned prior distribution to influence an upscaling implemented by the diffusion model of the detailed geological data; Element 14: wherein the diffusion training algorithm is further programmed apply an optimization process to the diffusion model using an objective function to optimize an accuracy of the diffusion model, the objective function being based on the feature preservation constraint; Element 15: wherein the machine readable instructions further comprise a geological model generator programmed to generate an upscaled geological model representative of the respective subsurface based on the upscaled geological data; Element 16: wherein the machine readable instructions further comprise a simulator programmed to simulate the upscaled geological model to model a behavior of the respective subsurface; and Element 17: wherein the simulator is programmed to generate simulation data based on the simulation, the simulation data characterizing a hydrocarbon in the respective subsurface, the simulation data being used for planning and/or extraction of the hydrocarbon.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or carry out combinations of special purpose hardware and computer instructions.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” or “attached” or “attached to” may indicate establishing either a direct or indirect connection and is not limited to either unless expressly referenced as such. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The term “based on” means “based at least in part on.” The terms “about” and “approximately” can be used to include any numerical value that can vary without changing the basic function of that value. When used with a range, “about” and “approximately” also disclose the range defined by the absolute values of the two endpoints, e.g. “about 2 to about 4” also discloses the range “from 2 to 4.” Generally, the terms “about” and “approximately” may refer to plus or minus 5-10% of the indicated number.

What has been described above include mere examples of systems, computer program products and computer-implemented methods. It is, of course, not possible to describe every conceivable combination of components, products and/or computer-implemented methods for purposes of describing this disclosure, but one of ordinary skill in the art can recognize that many further combinations and permutations of this disclosure are possible. The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

1. A computer-implemented method comprising:
receiving training data representative of previously captured, generated, and/or recorded detailed geological data for one or more subsurfaces of a planet;
training the diffusion model based on the training data to optimize parameters of the diffusion model;
receiving detailed geological data for a respective subsurface of the planet;
upscaling the detailed geological data using the trained diffusion model; and
generating upscaled geological data based on the upscaling.

2. The computer-implemented method of claim 1, further comprising generating an upscaled geological model representative of the respective subsurface based on the upscaled geological data.

3. The computer-implemented method of claim 1, further comprising simulating the upscaled geological model to model a behavior of the respective subsurface.

4. The computer-implemented method of claim 1, further comprising generating simulation data based on the simulation, the simulation data characterizing a hydrocarbon in the respective subsurface, the simulation data being used for planning and/or extraction of the hydrocarbon.

5. The computer-implemented method of claim 1, further comprising generating simulation data based on the simulation, the simulation data being provided to an output device.

6. The computer-implemented method of claim 1, wherein the training comprises providing the training data the diffusion model to learn a prior distribution over the preprocessed data.

7. The computer-implemented method of claim 6, wherein the diffusion model is trained according to a feature preservation constraint, the feature preservation constraint using the learned prior distribution to influence an upscaling implemented by the diffusion model of the detailed geological data.

8. The computer-implemented method of claim 7, wherein the training comprises applying an optimization process to the diffusion model using an objective function to optimize an accuracy of the diffusion model, the objective function being based on the feature preservation constraint.

9. A system comprising:
one or more computing platforms configured to:
train a diffusion model according to a feature preservation constraint;
process detailed geological data using the trained diffusion model to provide upscaled geological data;
generating an upscaled geological model based on the upscaled geological data;
simulating the upscaled geological model to simulate a subsurface of a planet;
outputting simulation data based on the simulation of the upscaled geological data; and
providing the simulation data to an output device.

10. The system of claim 9, wherein the simulation data characterizing a hydrocarbon in the respective subsurface, the simulation data being used for planning and/or extraction of the hydrocarbon.

11. The system of claim 9, wherein the feature preservation constraint using a learned prior distribution during a training to influence an upscaling implemented by the diffusion model of the detailed geological data.

12. The system of claim 11, wherein the one or more computing platforms are further configured to apply an optimization process to the diffusion model using an objective function to optimize an accuracy of the diffusion model during the training, the objective function being based on the feature preservation constraint.

13. The system of claim 12, wherein the one or more computing platforms are further configured to use training data to train the diffusion model to learn the prior distribution over the training data.

14. The system of claim 13, wherein the one or more computing platforms are further configured to preprocess the training data to provide pre-processed data, the pre-processed data being in a suitable form for ingestion by the diffusion model, the diffusion model being trained based on the pre-processed data.

15. One or more non-transitory computer-readable media comprising data and machine readable instructions executable by a processor, the machine readable instructions comprising:
a diffusion model programmed to:
upscale detailed geological data for a respective subsurface of a planet;
generate upscaled geological data based on the upscaling; and
a diffusion training algorithm programmed to train the diffusion model based on training data to optimize parameters of the diffusion model, the training data representative of previously captured, generated, and/or recorded detailed geological data for one or more subsurfaces of the planet.

16. The one or more non-transitory computer-readable media of claim 15, wherein the diffusion training algorithm is further programmed to train the diffusion model according to a feature preservation constraint, the feature preservation constraint using the learned prior distribution to influence an upscaling implemented by the diffusion model of the detailed geological data.

17. The one or more non-transitory computer-readable media of claim 15, wherein the diffusion training algorithm is further programmed apply an optimization process to the diffusion model using an objective function to optimize an accuracy of the diffusion model, the objective function being based on the feature preservation constraint.

18. The one or more non-transitory computer-readable media of claim 15, wherein the machine readable instructions further comprise a geological model generator programmed to generate an upscaled geological model representative of the respective subsurface based on the upscaled geological data.

19. The one or more non-transitory computer-readable media of claim 18, wherein the machine readable instructions further comprise a simulator programmed to simulate the upscaled geological model to model a behavior of the respective subsurface.

20. The one or more non-transitory computer-readable media of claim 19, wherein the simulator is programmed to generate simulation data based on the simulation, the simulation data characterizing a hydrocarbon in the respective subsurface, the simulation data being used for planning and/or extraction of the hydrocarbon.
